(19) United States
(12) Patent Application Publication
(10) Pub. No.: US 2004/0223242 A1
(43) Pub. Date: Nov. 11, 2004

(54) Baby view mirror

(76) Inventor: Dae S. Kim, Newton, MA (US)

Correspondence Address: Dae Sik Kim, 49 Floral Street, Newton, MA, 02461, US

(21) Appl. No.: 10/431,561

(22) Filed: May 8, 2003

(51) Int. Cl. G02B 7/182

(52) U.S. Cl. 359/872

(57) ABSTRACT

A device, for monitoring a baby in a safety seat on back seat of an automobile by a driver, mounts on interior liner and comprises of a thin plastic mirror, a U shaped mounting wire pin, attached to the backside of the mirror, having a pair of bendable substantially parallel legs extending out perpendicularly on one side of the mirror and a holder that holds the legs safely and helps in bending the legs.

### BACKGROUND OF THE INVENTION

1. Field of the Invention

This invention relates to an interior rear view mirror with an adjustable support, for monitoring a restrained baby in a safety car seat on the back seat.

2. Descriptions of the Prior Arts

Properly restrained child in an approved safety seat is legally required. Placement of child in middle of back seat is recommended because of proven hazard from mandated safety air bag exploding in a frontal collision and possible intrusion from side impact in a traffic accident or a rollover. For an additional protection of an infant under 20 pounds, a rear-facing seat is recommended.

To watch a child in back seat, a driver cannot use the factory-equipped rear view mirror (FERVM) or visor mounted mirror without compromising safe driving. In case of rear facing seat, at least two mirrors are required.

Prior art devices expanded field of vision to include the child in the back by adding a convex mirror over the FERVM or by attaching a separate adjustable mirror on the FERVM. These add-on objects pose an added safety hazard.

For monitoring a rear-facing infant, prior art devices generally use the FERVM as the front mirror. A second mirror is mounted on the back seat in Edgar (U.S. Pat. No. 6,491,403) and in Nolan-Brown (U.S. Pat. No. 5,285,321). Monahan et al (U.S. Pat. No. 6,354,708) added decorative or entertaining designs around the back seat mounted mirror. Rubin (U.S. Pat. No. 5,576,898) proposed ceiling mounted adjustable second mirror with an elaborate support.

As automotive industry is extremely cost competitive and all components are highly functionally refined based on their research and past experience, any add-on device and modification tend to compromise the original design objective. Thus, new device should be minimal in size and mass and cause minimal disturbance to the highly optimized original factory equipped components.

### SUMMARY OF THE INVENTION

This invention provides an efficient device for watching a baby in a safety seat on the back seat by a driver and a simple means of adjusting and installing the device with minimal disturbance or modification to the factory equipped components of a car.

This invention comprises of a substantially rectangular thin plastic mirror, a U shaped mounting wire pin attached to the backside of the mirror so that a pair of substantially parallel legs extends out perpendicularly on one side of the mirror and a holder that holds the legs safely and helps in bending the legs. For safety, the sharp four corner and edges of the mirror are smoothly rounded.

The size of wire and length of the legs are dictated by the size of the mirror, which in turn depends on the relative distances from the driver tO the mirror and the mirror to the baby and desired field of view. For monitoring front facing child, a 2×3 inch mirror, wire with 0.035 inch in diameter and one inch long legs are adequate. For monitoring rear facing infant, the second mirror and the wire must be considerably larger.

In this invention, a mirror is mounted on the interior fabric liner of an automobile by piercing and inserting properly bent legs behind the fabric. The mounting direction controls the horizontal orientation and the angle of the bends controls the vertical orientation of the mirror. For ease of the piercing, the legs end into a sharp point. Also to prevent the legs from pulling out accidentally, a small hooking barb, facing toward the fabric, is placed close to the end, as any accidental pull of the mirror tends to push the barb toward and hook the fabric. Only a combination of deliberate lifting of the barb away from the fabric and gentle pulling of the mirror dismounts the mirror from the liner.

For safe handling of this device, the legs are placed between an unevenly folded sturdy paperboard, which is also used to hold both legs for bending evenly and safely. The short side supports the weight of mirror and provides a panel for product identification. The longer side protects the back of the mirror, another lager panel for additional instruction and a hole for a displaying hook.

To minimize vibration, the bend must be very close to the side of mirror, which also touches the liner for an additional support. To maximize the stability, the legs must be as far apart as the mounting space on the mirror permits. For bending the legs forward, the edge of the mirror is used as a bending edge. For bending backward, a solid straight bending edge is needed. Additionally a pair of narrow pre-selected portions of wire is annealed by heating with a narrow flame for easy bending without affecting hardness of other part of the wire.

For a front facing child, the legs are bent toward the face of mirror by lifting up the far side of mirror as the paperboard holder and legs are firmly held down on a flat surface. The paperboard with the bent legs is held against ceiling just above the FERVM and a proper bending angle and the right direction of mount is checked before removing the paperboard and attaching the mirror at that spot.

For monitoring a rear-facing infant, a larger mirror can be attached on the ceiling, on the back seat or on the back deck behind the back seat. This selection depends on particular design of car. For this installation, you need a help of another person while you are seated in the driver seat. For more stable mounting of a large mirror, the legs are bent backward into an acute angle so that the legs support the weight more evenly. In this case, the hooking barbs must face backside of the mirror.

In many cases, a driver must monitor both a front facing child and a rear-facing infant at the same time. This invention lets the driver see both with small front mirror for the child and a combination of FERVM and a larger second mirror for the infant with a glance but without interfering each other's effectiveness.

Since the interior non-contact surface of almost all passenger vehicles are covered by a fabric liner, this invention provides a wide choice in locating a mirror for the best view. Since any impact to the plastic mirror can easily deform the wire and the mirror or tear the fabric liner, this invention is inherently safe.

### BRIEF DESCRIPTION OF THE DRAWINGS

The present invention will be understood better by reading the following description and accompanying drawings wherein:

FIG. 1 is a frontal view of this invention as displayed.

FIG. 2 is a backside view of this invention without the paperboard holder.

FIG. 3 is a perspective view of this invention with the legs bent forward.

### BEST MODE FOR CARRYING OUT THE INVENTION

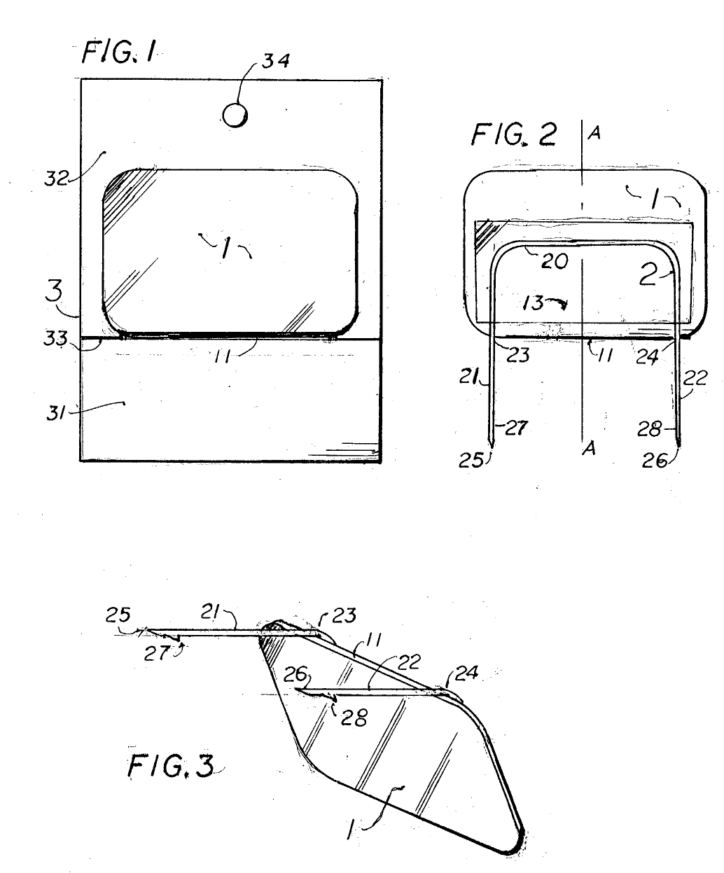

In FIGS. 1 and 2, a substantially rectangular, about 2×3×1/16 inches, thin plastic mirror 1 with a mounting side 11 is attached to a U-shaped support wire 2. Although the mirror 1 can have any shape, it preferably has symmetry to the mounting axis A-A and the straight mounting side 11 that is perpendicular to the axis. The mid part 20 of the wire 2 is firmly attached to the backside 12 of the mirror 1 with an adhesive tape 13. For a large mirror, a glued stiff paperboard replaces the tape 13 and the board is printed for decoration and information.

The wire 2 has a substantially identical pair of about one inch long mounting legs 21 and 22. Both starts with bending segments 23 and 24 near the mounting side 11, barbs 27 and 28, shown in FIG. 3 clearly, and ends to a sharp points 25 and 26.

The legs 21 and 22 are held between two parts 31 and 32 of an unevenly folded and partially glued paperboard holder 3. The short part 31 is slightly longer than the legs and slightly wider than the mirror. The longer part 32 has the same width but is long enough to cover the legs, the backside of the mirror 12 and space for a hanging hole 34. The short part 31 has a supporting edge 33, which is in contact with the mounting side 11 of the mirror 1.

In FIG. 3 the mounting legs 21 and 22 are bent forward where the barbs 27 and 28 are facing down. If the legs need to be bent backward into an acute angle for a large mirror, the barbs must face the opposite direction.

It is understood that the above description is given merely by way of illustration and not in limitation of the invention and that various modifications may be made thereto without departing from the spirit of the invention as claimed.

I claim:

1. A device for monitoring a child in a safety seat in the back seat of automobile by a driver and means of adjusting and installing said device on the interior lining of an automobile safely comprising of
a thin plastic mirror with a mounting side,
a U-shaped mounting wire pin, attached to the backside of said mirror, having a pair of substantially identical and parallel mounting legs, extending outward from said mounting side perpendicularly, with bendable segments near said mounting side and sharp point at the ends of said pin for easy piercing and
a means of holding and handling said mirror with said legs safely.

2. The device of claim 1 wherein said mirror is symmetrical about a mounting axis that is parallel to and lies between said pair of legs.

3. The device of claim 1 wherein said legs have barbs near said ends for preventing an accidental dismount from the liner.

4. The device of claim 1 wherein said means of holding and handling is an unevenly folded sheet whose long side protect the backside of said mirror and an additional space for a hole for displaying hook and whose short side support the said mounting side of said mirror and that hold said legs securely between two sides.
